(19) United States
(12) Patent Application Publication
(10) Pub. No.: US 2015/0166215 A1
(43) Pub. Date: Jun. 18, 2015

(54) Re-closable Food Container

(71) Applicant: Hub Folding Box Company, Inc., Mansfield, MA (US)

(72) Inventor: H. Anthony DiRico, Milton, MA (US)

(21) Appl. No.: 14/568,655

(22) Filed: Dec. 12, 2014

Related U.S. Application Data
(60) Provisional application No. 61/915,195, filed on Dec. 12, 2013.

(51) Int. Cl. B65D 5/56; B31B 1/90; B31B 7/00; B65D 5/64

(52) U.S. Cl. CPC B65D 5/563; B65D 5/643; B31B 1/90; B31B 7/00

(57) ABSTRACT

A hermetically sealed stand-alone paperboard folding carton having barrier properties integrated with a peelable, re-sealable closure. The container includes: a skived and hemmed portion of the laminated paperboard carton; a bottom film strip sealed to the inner side of the bottom carton flaps; and a top film assembly sealed to the inner side of the top carton flaps, the top film assembly comprising a re-sealable closure. The carton uses a flat, die cut, scored paperboard blank having a barrier film laminated to one side of the paperboard; an area of interior glue flap of the cut blank is skived to remove a thickness of paperboard material; a skived area of the blank is hemmed to seal the skived area over the un-skived area of the blank, a strip of barrier film is heat-sealed to the four bottom carton flaps; the bottom flaps are folded and glued; the container is filled; an additional strip of peelable, sealable film is heat sealed to top carton flaps; and the top carton flaps are folded and glued.

### CROSS REFERENCE TO RELATED APPLICATIONS

This application claims benefit of prior U.S. Provisional Application No. 61/915,195, filed on Dec. 12, 2013. The application is incorporated by reference in its entirety.

### TECHNICAL FIELD

This invention relates to food containers and more particularly to containers for items such as food that that the user does not consume in a single event, requiring multiple access and closures before the entire contents are consumed.

### BACKGROUND

Numerous products packaged in folding cartons are susceptible to degradation due to the presence of moisture and oxygen. A barrier (e.g. a barrier to transfer of moisture and oxygen), provided within the package, protects the quality of such packaged products, for example, food, tobacco, personal hygiene and medical products. Ways to measure the effectiveness of such barriers include moisture transfer rate (WVTR) and oxygen transfer rate (OTR). WVTR is measured using test method ASTM F-1249 and OTR is measured using test method ASTM D-3985.

While standard folding carton closures usually provide adequate product retention, the top and bottom of the closed package can have small voids even when they are sealed. These voids can allow moisture and oxygen to enter the interior of the carton. In addition, there is a need for packaging that allows multiple accesses and re-closure for products which are consumed over a period of time, such as products that are presented in individual units, (e.g., pieces of candy or sticks of gum).

A common practice to protect food products such as cereal and confectionary is to provide a primary (inner) and secondary (outer) package, for example, a multiple access barrier bag as the primary package, and a non-barrier folding carton as the secondary package. In this instance, the food product is dispensed into a barrier bag, which has been hermetically sealed on the sidewall and bottom end prior to filling. The top end of the bag is then hermetically sealed after the product has been dispensed into the bag. The bag is then inserted into a non-barrier folding carton. This packaging concept is commonly referred to as “bag-in-a-box” packaging.

Another common practice is to overwrap a barrier film around a folding carton, container or formed tray holding a product. In this instance, the primary or inner package is a non-barrier carton, container or tray, and the secondary or outer package is the barrier film. Typically, once the outer film is breached to access product, product protection is compromised after the first use.

U.S. Pat. No. 8,114,451 describes a packaging method wherein the food product is contained in a primary package (a tray) inserted into an outer package (a sealed bag). The external bag has a peelable, sealable closure to allow multiple access. Alternatively, a film may be sealed directly to the rim of a molded tray.

U.S. Pat. No. 4,790,436, describes a bag in a box, in which the bag has a peelable, sealable closure. When the outer secondary package—the folding carton—is opened, the inner bag becomes accessible. The peelable, sealable bag may also be encased in a frame.

### SUMMARY

The invention provides a standalone paperboard folding carton package, which is hermetically sealed and has barrier properties. A peelable, sealable feature allows convenient multiple access and re-closure.

In one aspect the invention generally features a reusable folded paperboard container comprising paperboard that has an inner laminated barrier film to establish barrier and a hermetic seal. The container has folded bottom carton flaps and top carton flaps. Interior glue flaps of the paperboard are skived and hemmed, so that any exposed edge inside the package is protected by the laminated barrier film. A bottom film strip is sealed to the inner side of the bottom carton flaps. A top film assembly comprising a re-sealable closure is sealed to the inner side of the top carton flaps.

Preferably the finished container exhibits an oxygen transfer rate (OTR) of less than 10 cc/100 in sq/24 hours and a moisture transfer rate (MVTR) of less than 1.5 grams/100 sq in/24 hours, when measured by ASTM D-3985 and ASTM F-1249, respectively. A product (e.g., a food, tobacco, personal hygiene or medical product) is sealed within the container.

Also preferably, the top film assembly has a first top strip, with a die cut opening sealed to the inner top carton flaps, and a second top strip re-sealably attached to the first top strip to seal over the opening. The second top strip is larger than the opening in the first top strip, and the second top strip may be permanently attached to the first top strip around a first portion of the opening and re-sealably attached to the first top strip around a second portion of the opening. The second top strip comprises a pull tab to allow the user to pull the strip away from the opening to access the contents and then to replace and reseal the strip.

The container is manufactured by (a) providing a flat, die cut, scored paperboard blank having a barrier film laminated to one side of the paperboard; (b) skiving an area of the interior glue flap of the cut blank to remove a thickness of paperboard material; (c) folding and sealing the skived area of the interior glue flap to the un-skived area of the interior glue flap; (d) sealing the side panel to the interior glue flap; (e) heat sealing a strip of barrier film to the four bottom carton flaps; (f) folding and gluing the flaps; (g) filling the container; (h) heat sealing an additional strip of peelable, sealable film to top carton flaps; and (i) folding and gluing the four top carton flaps.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a flat blank carton with a skived portion of glue flap identified with hatch marks.

FIGS. 2A and 2B shows a two stage process of removing a portion of paperboard layer of the glue flap (skiving), then folding the remaining paperboard layer and the entire film layer and adhering the skived portion of the glue flap to the un-skived paperboard portion of the glue flap (hemming).

FIG. 3 shows a partially formed open ended folding carton

FIG. 4 shows the bottom open end of the carton with a non-peelable, sealable barrier film sealed to the inner side of the four open bottom end flaps (major and minor bottom closure panels and dust flaps). Sealed areas are identified by hatch marks. Although not shown, a peelable, sealable film may be substituted for the non-peelable, sealable barrier film.

FIG. 5 shows the top open end of the carton with a barrier peelable, sealable film sealed to the inner side of the four open top end flaps (major and minor top closure panels and dust flaps). The sealed areas are identified by hatch marks. The peelable, sealable film is a multi-layered laminated film, with one interior layer made of a pressures sensitive adhesive.

FIG. 6 shows the top open end of the carton with the peelable, sealable peel strip pulled back to expose a die cut area in the bottom layer of the laminated peelable, sealable film.

FIG. 7 shows the top peel strip re-applied to the bottom layer of the of the barrier film. The dust flaps are folded inward, carrying a portion of the top layer barrier film towards the interior of the carton.

FIG. 8 shows the top closure minor panel folded inward and over the dust flaps, carrying an additional portion of the top layer barrier film towards the interior of the carton. A glue strip is applied to the top closure minor panel.

Like reference symbols in the various drawings indicate like elements.

### DETAILED DESCRIPTION

In general, the packaging includes a hermetic folding carton comprising an outer paperboard layer, a polymer laminant layer, and an inner barrier polymer film layer. In addition, one open end of the carton is capped with a film having similar barrier properties as the inner barrier film laminated to the paperboard. The second open end is capped with a peelable, sealable multilayer barrier polymer film comprising a bottom barrier film layer, a middle layer of a sealable pressure sensitive adhesive coating and a top barrier film layer. The pressure sensitive coating allows for the peeled top film to be resealed to the entire film structure. The peelable, sealable film also has barrier properties similar to the barrier properties as the inner barrier film laminated to the paperboard.

The design of the carton exhibits the non-laminated side of the paperboard as the exterior of the carton and the film-laminated side of the paperboard as the interior of the carton. The barrier film prohibits excessive moisture or oxygen, which are detrimental to the specified shelf life of the packaged product, from entering into the formed and sealed package through the paperboard surface of the carton.

The skiving and hemming of the interior glue flap of the cut blank prevents entry of moisture and/or oxygen through interior exposed edges. During skiving, a high percentage of the paperboard thickness is reduced by removing a thin, narrow strip of material from the paperboard surface. Hemming folds and seals the skived area over the un-skived portion of the carton blank, creating an exposed barrier film edge approximately the same thickness as the original laminated paperboard. This exposed film edge prevents moisture and oxygen from entering the interior of the folded carton. During the carton forming, filling and sealing process, a strip of barrier film is heat sealed to the four bottom carton flaps. The flaps are then folded and glued. The carton proceeds through the filling line, and, once it is filled, an additional strip of peelable, sealable film is heat sealed to the four top carton flaps. This final film sealing process creates a hermetic seal. The four top carton flaps are then folded and glued.

The paperboard layer preferably is a paperboard base stock between 0.006 and 0.040 inches thick and can be identified as, but not limited to, Solid Bleached Sulphate (SBS), Solid Unbleached Sulphate (SUS), and Clay Coated News (CCN).

The barrier film laminated to the board can be a combination of film layers made from, without limitation, linear low density polyethylene, low density polyethylene, medium density polyethylene, high density polyethylene, polypropylene and polyethylene terephthalate. The film may also be metalized to increase barrier properties. Heat sealable foil layers may be substituted or used in combination with the films mentioned above.

The laminant used to adhere the barrier film or foil to the paperboard can be an extruded or co-extruded layer or layers of a resin or resins made from, but not limited to, linear low density polyethylene, low density polyethylene, medium density polyethylene, high density polyethylene, polypropylene, polyethylene terephthalate, EMA, EVA or other copolymers. In addition film or foils may be adhered to the paperboard using aqueous adhesive coatings.

Seals between the film, foil and paperboard layers throughout the entire forming process of the carton can be accomplished using a combination of sealing methods such as, but not limited to, applications of adhesives, heat and pressure, infrared, ultrasonic, ultraviolet and radio frequency.

An embodiment of the invention is illustrated in the Figures.

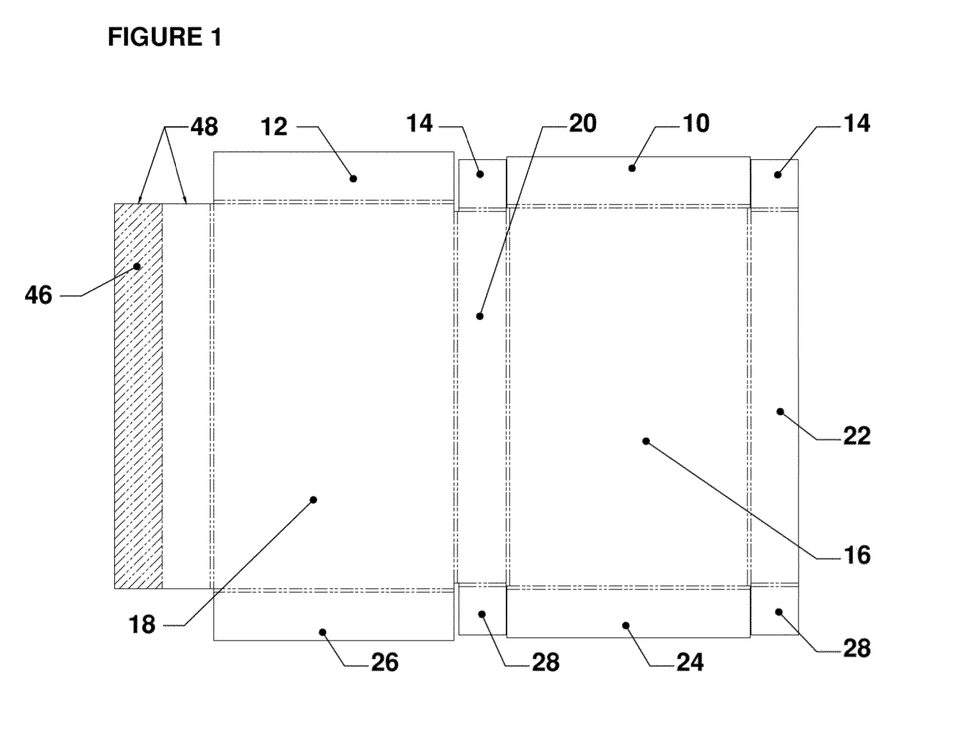

FIG. 1 shows a flat, die cut carton blank with front panel 16, rear panel 18, left side panel 20, right side panel 22, top dust flaps 14, bottom dust flaps 28, top closure minor panel 10, top closure major panel 12, bottom closure minor panel 24, bottom closure major panel 26, and interior glue flap 48 including skived paperboard area 46 shown with hatch marks.

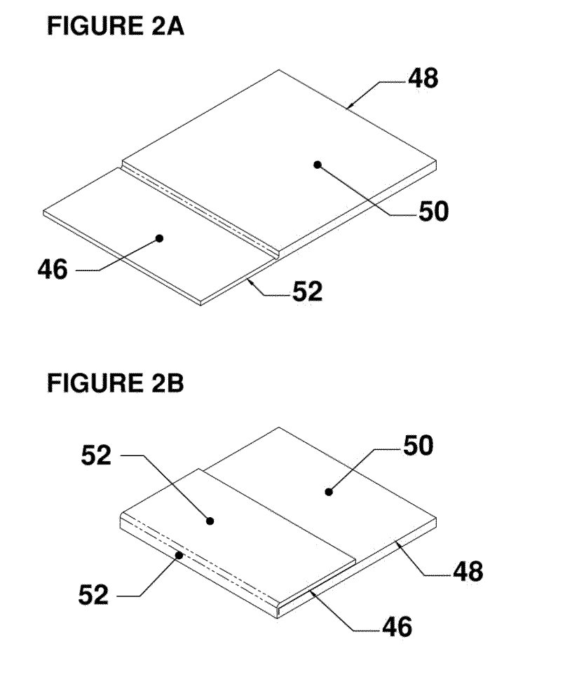

FIG. 2A shows interior glue flap 48 with paperboard 50 as unskived and paperboard 46 skived, meaning that a portion of the paperboard layer 50 has been removed in a skiving process. Not shown is barrier film 52 laminated to the opposite side of the paperboard layer.

FIG. 2B shows that skived portion 46 is folded over and sealed, also known as hemmed, to the unskived paperboard 50. During the hemming process barrier film 52 now becomes the exposed internal edge of the interior glue flap 48.

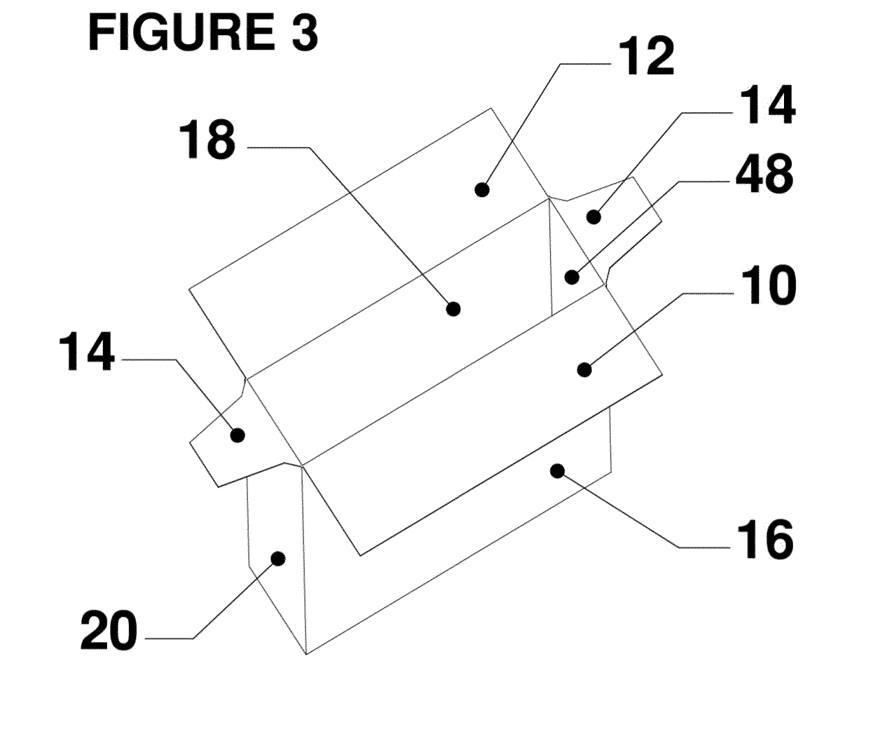

FIG. 3 shows a partially folded and side seem-sealed carton, with right side panel 22 (not shown) sealed to the interior glue flap 48. Rear panel 18 and interior glue flap 48 are shown as the interior of the carton. Front panel 16 and left panel 20 are shown as the exterior of the carton. Also shown are unsealed top closure minor panel 10, top closure major panel 12 and top dust flaps 14.

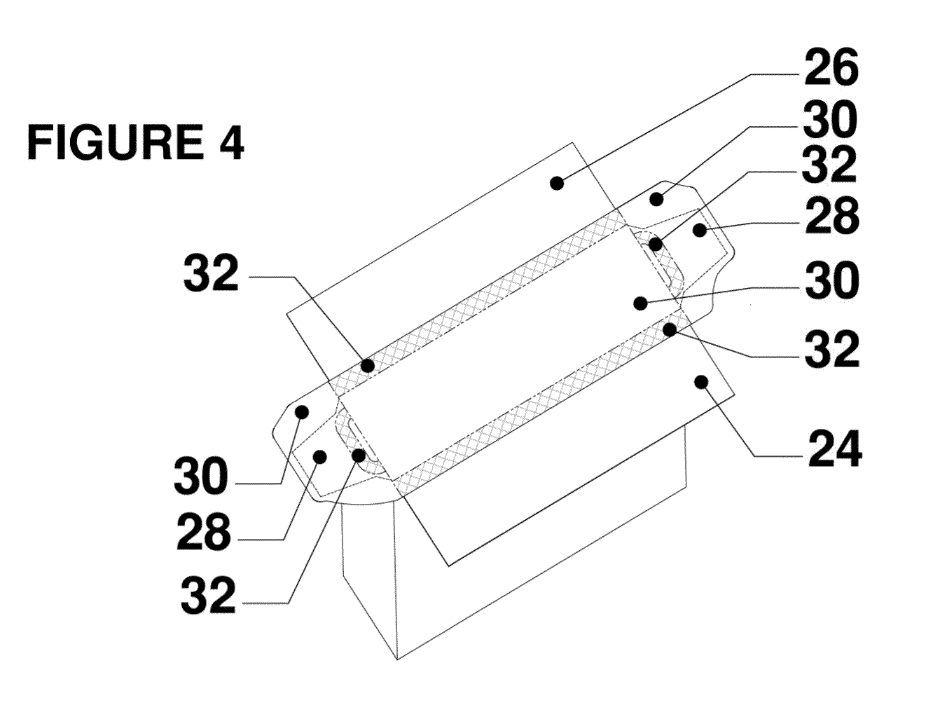

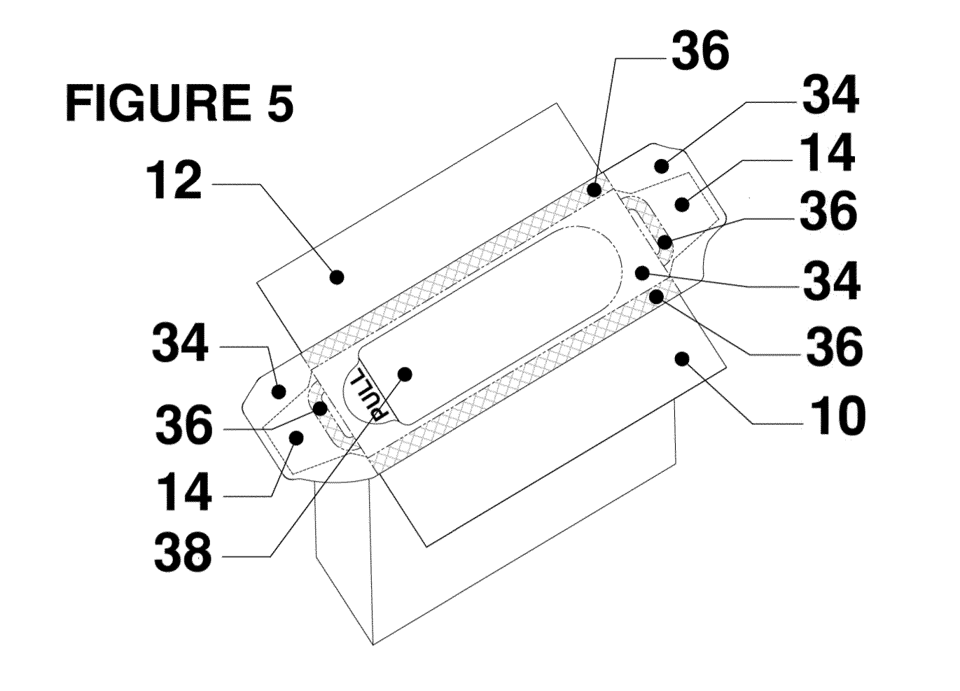

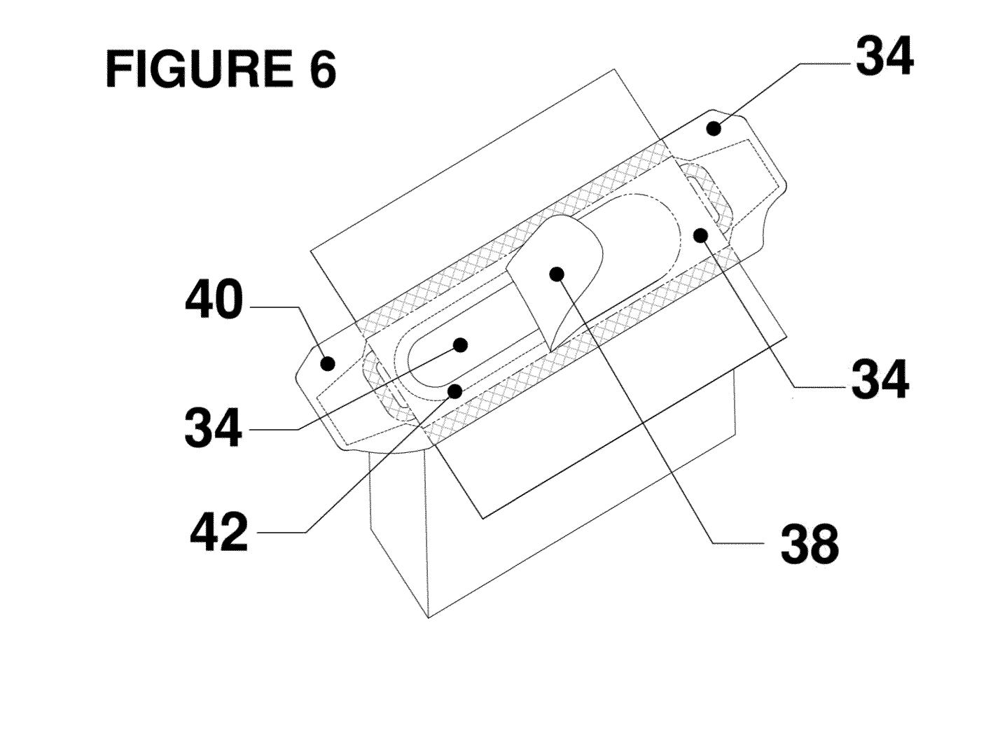

FIG. 4 shows the open end of the bottom of a carton, with a bottom barrier film layer 30 heat sealed to a portion of bottom closure minor panel 24, bottom closure major panel 26 and bottom dust flaps 28. Bottom heat sealed areas 32 are defined with hash marks. Final bottom closure process is accomplished by folding bottom dust flaps 28, minor bottom panel 24 and major bottom panel 26 inward, with a final sealing process creating a hermetic seal. Final bottom closure process is a duplicate process of the final top closure process, which will be described in more detail in FIG. 5 and FIG. 6 and the description of the final folding process.

FIG. 5 shows the open end of the top of a carton, with a top peelable, sealable barrier film 34 heat sealed to a portion of top closure minor panel 10, top closure major panel 12, and top dust flaps 14. Top heat seal areas 36 are defined with hash marks. The top peelable, sealable film 34 is a multi-layered laminated film, with one interior layer made of a pressures sensitive adhesive. This adhesive layer allows the consumer to peel a portion of the top layer (or layers) of the multilayered film apart, exposing a die cut area in the bottom layer (or layers) of the laminated film. The portion of the top layer which is peeled from the bottom layer in commonly referred to as peel strip 38.

FIG. 6 shows the open end of the top of the carton, with peel strip 38 partially pulled back to expose a die cut area 40 in the bottom layer 42 of the laminated film, thereby allowing access to the packaged product. Also exposed is a portion of the laminated bottom layer 42 of the peelable, sealable film 34, which has an interior layer of pressure sensitive adhesive applied to the top of bottom layer 42. The pressure sensitive interior layer of the film retains significant multi-use tack properties to allow the consumer to close peel strip 38 back over the pressure sensitive adhesive and the exposed bottom layer 42 of the film, thereby locking in the remaining packaged product.

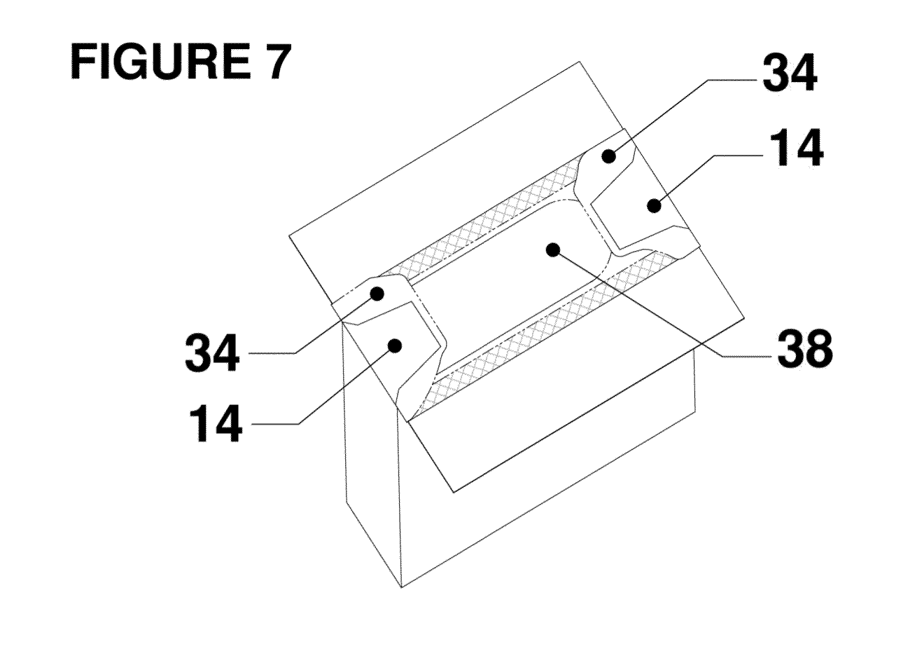

FIG. 7 shows the initial top closure process, whereby dust flaps 14 are folded inward, carrying a portion of the attached barrier film 34 back towards the center of the top area of the carton and over the now partially exposed peel strip 38.

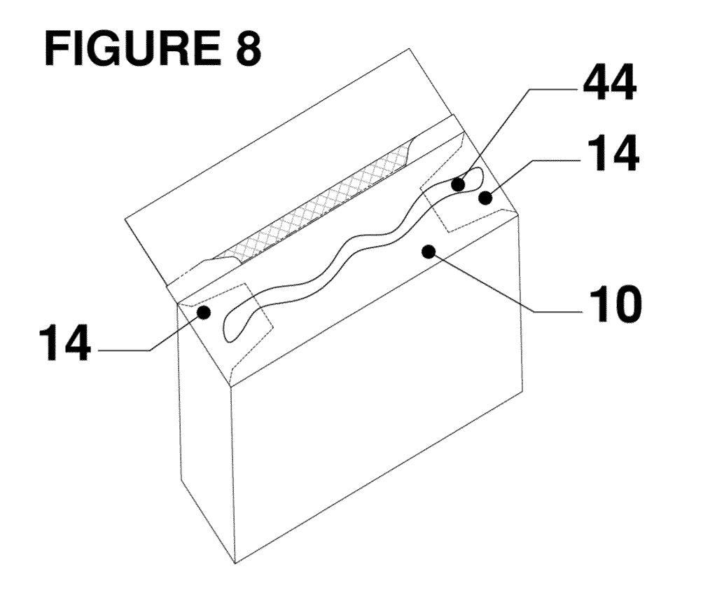

FIG. 8 shows an additional closure process, whereby the top closure minor panel 10 is folded inward and over the top dust flaps 14, carrying an additional portion of the top layer barrier film towards the center of the carton. Peel strip 38 (not shown) is now entirely covered. A glue strip 44 is applied to the length of the top closure minor panel 10.

Not shown is the final process of folding the top closure major panel 12 inward, carrying the final portion of the top layer barrier film 34 towards the interior of the carton. Pressure is then applied to the outer side of the top closure major panel 12 in order to create a destructive bond between the bottom of top closure minor panel 12, glue strip 44 and the top side of top closure minor panel 10. Access to peel strip 38 is now denied unless the carton is torn open.

A number of embodiments of the invention have been described. Nevertheless, it will be understood that various modifications may be made without departing from the spirit and scope of the invention. Accordingly, other embodiments are within the scope of the following claims.

What is claimed is:

1. A reusable folded paperboard container comprising paperboard laminated on the inside with a barrier film that establishes a hermetic seal, the container comprising
(a) folded bottom carton flaps and top carton flaps;
(b) skived and hemmed interior glue flaps;
(c) a bottom film strip sealed to the inner side of the bottom carton flaps; and
(d) a top film assembly sealed to the inner side of the top carton flaps, the top film assembly comprising a re-sealable closure.

2. The container of claim 1 in which the container exhibits an oxygen transfer rate (OTR) of less than 10 cc/100 in sq/24 hours.

3. The container of claim 1 in which the container exhibits a moisture transfer rate (MVTR) of less than 1.5 grams/100 sq in/24 hours.

4. The container of claim 2 in which the container exhibits a moisture transfer rate (MVTR) of less than 1.5 grams/100 sq in/24 hours.

5. The container of claim 1 further comprising a product sealed within the container.

6. The container of claim 5 in which the product is a food product.

7. The container of claim 5 in which the product is a medical product.

8. The container of claim 5 in which the product is a tobacco product.

9. The container of claim 5 in which the product is a personal hygiene product.

10. The container of claim 1 in which the top film assembly comprises a first top strip sealed to the inner top carton flaps, the first top strip having an opening and a second top strip re-sealably attached to the first top strip to seal the opening.

11. The container of claim 10 in which the second top strip is larger than the opening in the first top strip, and the second top strip is permanently attached to the first top strip around a first portion of the opening and re-sealably attached to the first top strip around a second portion of the opening.

12. The container of claim 10 in which the second top strip comprises a pull tab.

13. A method of manufacturing the paperboard container of claim 1 comprising,
(a) providing a flat, die cut, scored paperboard blank having a barrier film laminated to one side of the paperboard;
(b) skiving an area of interior glue flap of the cut blank to remove a thickness of paperboard material;
(c) hemming (folding and sealing) the skived area over the un-skived area of the interior glue flap of the blank;
(d) sealing the interior glue flap to a side panel;
(e) heat sealing a strip of barrier film to the four bottom carton flaps;
(f) folding and gluing the flaps;
(g) filling the container;
(h) heat sealing an additional strip of peelable, sealable film to top carton flaps;
(i) folding and gluing the four top carton flaps.
